(19) United States
(12) Patent Application Publication
(10) Pub. No.: US 2015/0216199 A1
(43) Pub. Date: Aug. 6, 2015

(54) HIGH PROTEIN GUMMY PRODUCT AND PROCESS OF MAKING

(71) Applicant: RAP Nutrition LLC, Oakbrook Terrace, IL (US)

(72) Inventors: Tessa Porter, Forest Park, IL (US); Bernie Woziwodzki, Elk Grove Village, IL (US); Michael Sayles, Frankfort, IL (US)

(21) Appl. No.: 14/490,832

(22) Filed: Sep. 19, 2014

Related U.S. Application Data
(60) Provisional application No. 61/991,131, filed on May 9, 2014.
(60) Provisional application No. 61/936,708, filed on Feb. 6, 2014.

(51) Int. Cl. A23G 3/44; A23G 3/38; A23G 3/42

(52) U.S. Cl. CPC A23G 3/44; A23G 3/42; A23G 3/38; A23V 2002/00

(57) ABSTRACT

A gummy snack food product comprising a high amount of protein and process of making the gummy product are provided. The disclosed gummy product and process provides consumers with high quality protein in a new gummy snack food product. The process utilizes chemical properties of high quality protein, such as whey protein isolate, to prevent thickening as well as grainy, clumpy, and/or chalky texture in the finished gummy product.

### CROSS REFERENCE TO RELATED APPLICATIONS

The present application claims benefit of U.S. Provisional Application Ser. Nos. 61/936,708, filed on Feb. 6, 2014, and 61/991,131, filed on May 9, 2014, which applications are incorporated herein by reference in their entirety.

### BACKGROUND

Gummy products are a popular snack food product. Gummies typically have a gel or gel-like structure and texture and are produced in a variety of shapes and flavors. Recently, gummy products have been supplemented with vitamins and/or fiber as a means of providing vitamins and minerals in an alternative form to vitamin and fiber supplements, which traditionally have been provided in a tablet or powder form.

Protein is a building block for new cells and is essential in helping to build muscle and maintain lean muscle mass, which is important for both weight loss and optimum sports performance. Protein supplements are therefore commonly used to help build muscle, lose weight, or supplement the lack of protein in one's diet. Protein supplements have traditionally been provided in a powder form that is mixed with a liquid such as water or milk to form a shake, a pre-mixed shake, or bar form. Consumers currently are not able to incorporate significant amounts of high quality protein into their diets through gummy snack food products.

Protein has not previously been successfully incorporated into a consumer-acceptable gummy format. In gummy products, high levels of protein often create an undesired taste and/or grainy, clumpy, and/or chalky texture in the finished product. In addition, protein is sensitive to many processing parameters for producing a gummy snack food product, such as shear, heat, and pH, resulting in clumping and/or thickening which prevents the product from being pumped and/or deposited.

A gummy product comprising a high level of protein and having a taste and texture that consumers associate with a traditional gummy snack food product would be desirable.

### SUMMARY

A gummy snack food product comprising a high amount of protein is disclosed. The gummy snack food product generally comprises from about 10% to about 40% high quality protein by weight; from about 15% to about 40% of glucose syrup by weight;

from 0% to about 20% of a first sugar alcohol by weight; from 0% to about 10% of a second sugar alcohol by weight, the second sugar alcohol comprising glycerin; from 0% to about 10% of a third sugar alcohol by weight, the third sugar alcohol comprising sorbitol; from about 0.5% to about 11% gelatin by weight; from 0% to about 5% acid by weight; and from about 10% to about 30% water by weight. The high quality protein can be whey protein. In embodiments, the whey protein comprises whey protein concentrate, whey protein isolate, whey protein hydrolysate, or a combination thereof. Other suitable high quality protein includes milk protein concentrate, milk protein isolate, casein, micellar casein, caseinate protein, casein protein hydrolysate, vegetable proteins, vegetable protein isolates, egg protein, egg white protein, beef protein isolate, Quorn, mycoprotein and mixtures thereof. In embodiments, glucose syrup comprises corn syrup, tapioca syrup, agave syrup, brown rice syrup, high maltose syrup, invert sugar, or a mixture thereof. The gummy product can further include one or more flavorants, colorants, vitamins, minerals, and/or supplemental amino acids. In embodiments, the gummy product comprises a gelatin matrix interrupted by aggregates of the high quality protein.

A process of making the high protein gummy product is also disclosed. The process provides a gel slurry for use in a molding or extruding process to form the gummy product. The process generally includes forming a mixture comprising from about 15% to about 40% (w/w) corn syrup, from 0% to about 20% (w/w) of a first sugar alcohol, from 0 to about 10% (w/w) of second sugar alcohol, from 0 to about 10% (w/w) of third sugar alcohol, and from about 10% to about 30% (w/w) water; cooking the mixture to form a sugar mixture; cooling the sugar mixture to a solids content of about 75% to about 95% solids; mixing the cooled sugar mixture with an acid solution to form a sugar-acid mixture having a pH of about 2 to about 4; mixing the sugar-acid mixture with a gelatin slurry to form a sugar-gelatin mixture, the gelatin slurry comprising from about 35% to about 60% (w/w) hydrated gelatin; mixing the sugar-gelatin mixture with a protein mixture to form a gel mixture; and depositing the gel mixture into a starch mold. The protein mixture typically includes water and from about 25% to about 65% (w/w) high quality protein.

### BRIEF DESCRIPTION OF THE DRAWINGS

FIG. 1 illustrates an example method for producing a high protein gummy product.

FIG. 2 illustrates a cross sectional view of an example high protein gummy product.

FIG. 3 shows a photomicrograph of a cross section of a first example high protein gummy product.

FIG. 4 shows a photomicrograph of a cross section of a second example high protein gummy product.

### DETAILED DESCRIPTION

A gummy snack food product comprising a high amount of protein and process of making the gummy snack food product are provided. The disclosed gummy product and process provides consumers with high quality protein in a new gummy format which has not been previously accessible to consumers. The process utilizes chemical properties of high quality protein, such as whey protein isolate, to prevent thickening as well as grainy, clumpy, and/or chalky texture in the finished gummy product. The disclosed process hydrates and mixes the protein with a gummy slurry to create a homogenous mixture that is able to flow and deposit in molding or extruding processes.

In one aspect, the gummy product comprises from about 10% to about 40% high quality protein by weight; from about 15% to about 55% of glucose syrup by weight; from 0% to about 20% of a first sugar alcohol by weight; from 0% to about 10% a second sugar alcohol by weight, the second sugar alcohol comprising glycerin; from about 0.5% to about 11% gelatin by weight; from 0% to about 5% acid by weight; from 0% to about 0.5% sucrose esters; and from about 10% to about 30% water by weight.

In another aspect, the gummy product comprises from about 10% to about 40% high quality protein by weight, from about 15% to about 55% of glucose syrup by weight, from about 0.5% to about 11% gelatin by weight, from 0% to about 5% acid by weight, and from about 10% to about 30% water by weight.

In some embodiments, the gummy product comprises the high quality protein at from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w).

A high quality protein contains essential amino acids. An essential amino acid is an amino acid that cannot be synthesized de novo and therefore must be supplied by diet. For humans, there are nine essential amino acids. These nine essential amino acids are phenylalanine, valine, threonine, tryptophan, methionine, leucine, isoleucine, lysine, and histidine. Preferably the high quality protein comprises the nine essential amino acids. In some embodiments, the high quality protein further comprises cysteine, tyrosine, and/or arginine. In some embodiments, the high quality protein further comprises one or more conditionally essential amino acids selected from arginine, cysteine, glycine, glutamine, proline, serine, and tyrosine. Conditionally essential amino acids are not normally required in a diet, but may be supplied exogenously to certain populations of people that do not synthesize them in adequate amounts.

Examples of high quality protein include but are not limited to whey protein, milk protein concentrate, milk protein isolate, casein, micellar casein, caseinate protein, casein protein hydrolysate, vegetable protein or vegetable protein isolate including but not limited to pea protein, brown rice protein, sprouted brown rice protein, hemp protein, soy protein, soy protein isolate, egg protein, egg white protein, beef protein isolate, Quorn, mycoprotein and mixtures thereof. In embodiments, the high quality protein is whey protein. The whey protein can be a whey protein concentrate, whey protein isolate, whey protein hydrolysate, micronparticulated whey, or mixture thereof. Examples of whey protein concentrates include but are not limited to Barflex™ (Glanbia Nutritionals, Monroe, Wis.), and Hilmar WPC™ (Hilmar Cheese Company, Hilmar, Calif.). Examples of whey protein isolates include but are not limited to BevWise I-300™ (Glanbia Nutritionals, Monroe, Wis.), Europrotein WPI 90™ (Euro Proteins, Wapakoneta, Ohio), BiPro WPI™ (Davisco Foods International, INC., Eden Prairie, Minn.), and Protient WPI™ (Protient, St. Paul, Minn.). Examples of whey protein hydrosylates include but are not limited to Hydrovon WPI (Glanbia Nutritionals, Monroe, Wis.), and BioZate (Davisco Foods International, Inc., Eden Prairie, Minn.).

In embodiments, the gummy product comprises the whey protein at from about 10% to about 40% (w/w); from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w). In an embodiment, the whey protein comprises at least about 80% protein by weight. In another embodiment, the whey protein comprises at least about 90% protein by weight. In another embodiment, the whey protein comprises at least about 95% protein by weight.

In some embodiments, the whey protein is whey protein isolate. The whey protein isolate comprises at least 90% protein by weight. The whey protein isolate can be partially hydrolyzed and/or mixed with a whey protein hydrolysate. In embodiments, the gummy product comprises whey protein isolate from about 10% to about 40% (w/w), from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w). In an embodiment, the whey protein isolate has an isoelectric point from about 4 to about 5.5; from about 4.2 to about 4.8; from about 4.5 to about 5; or from about 4.4 to about 4.6.

In some embodiments, the gummy product comprises milk protein concentrate, milk protein isolate, or mixtures thereof at from about 10% to about 40% (w/w); from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w). Examples of milk protein concentrates include but are not limited to Nutrilac CH7813 (ARLA Foods, Skanderborgvej, Denmark), Promilk 852B (Ingredia Dairy Ingredients, Arras Cedex, France), and Kerry RD4003-73B (Kerry Food Ingredients, Beloit, Wis.). Milk protein isolate is a co-precipitate of casein and whey proteins and usually ranges from about 90% to about 95%, or higher, total protein content. Milk protein isolates are commercially available from producers such as Glanbia, Davisco, Fonterra and Europro. In some embodiments, the gummy product comprises casein, caseinate protein, casein protein hydrolysate, acid casein, rennet casein, or mixtures thereof at from about 10% to about 40% (w/w); from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w). Acid casein can be produced by acidifying pure, pasteurized skim milk to a pH of about 4.6. Rennet casein can be produced by precipitating casein from pure, pasteurized skim milk with an enzyme.

In some embodiments, the gummy product comprises vegetable protein, vegetable protein isolate, or mixtures thereof at from about 10% to about 40% (w/w); from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w). The vegetable protein can include pea protein, brown rice protein, sprouted brown rice protein, hemp protein, soy protein, soy protein isolate, and mixtures thereof.

Examples of glucose syrups include corn syrup, tapioca syrup, agave syrup, brown rice syrup, high maltose syrup, invert sugar, and mixtures thereof. In an embodiment, the gummy product comprises glucose syrup from about 15% to about 40%; (w/w) from about 15% to about 35% (w/w); from about 15% to about 30% (w/w); from about 15% to about 25% (w/w); or from about 15% to about 20% (w/w). In another embodiment, the gummy product comprises glucose syrup from about 0% to about 35% (w/w); from about 5% to about 30% (w/w); from about 1% to about 25% (w/w); or from about 5% to about 20% (w/w).

In embodiments, the glucose syrup is a corn syrup comprising a dextrose equivalent (DE) of about 40 to about 70 DE. In an embodiment, the corn syrup comprises a DE of about 55 to about 62 DE. In some embodiments, the corn syrup is 62 DE. The corn syrup can be a high fructose corn syrup. In an embodiment, the gummy product comprises corn syrup from about 15% to about 55% (w/w); from about 15% to about 40% (w/w); from about 15% to about 35% (w/w); from about 15% to about 30% (w/w); from about 15% to about 25% (w/w); or from about 15% to about 20% (w/w). In another embodiment, the gummy product comprises corn syrup from about 0% to about 35% (w/w); from about 5% to about 30% (w/w); from about 1% to about 25% (w/w); or from about 5% to about 20% (w/w).

In an embodiment, the glucose syrup comprises tapioca syrup, agave syrup, brown rice syrup, high maltose syrup, invert sugar, or a mixture thereof. In such an embodiment, the gummy product comprises from about 0% to about 35% (w/w); from about 15% to about 35% (w/w); from about 15% to about 30% (w/w); from about 15% to about 25% (w/w); or from about 15% to about 20% (w/w) syrup by weight. In another embodiment, the gummy can include an amount of tapioca syrup, agave syrup, brown rice syrup, glucose syrup, high maltose syrup, invert sugar, or a mixture thereof to reduce the amount of corn syrup in the gummy product.

The sugar alcohol has a general formula of H(HCHO)ₙ₊₁H. In an embodiment, n is from 4 to 11. In another embodiment, n is from 3 to 5. Examples of suitable sugar alcohols include but are not limited to arabitol, erythritol, glycerin, lactitol, isomalt, hydrogenated starch hydrolysate, maltitol, mannitol, sorbitol, xylitol, and the like. The sugar alcohol can be a mixture of two or more sugar alcohols. In an embodiment, the sugar alcohol comprises arabitol, erythritol, glycerin, lactitol, isomalt, hydrogenated starch hydrolysate, maltitol, mannitol, sorbitol, xylitol, or a combination thereof. In some embodiments the gummy product comprises sugar alcohol from about 0% to about 20% (w/w); from about 5% to about 15% (w/w); from about 9% to about 12% (w/w); from about 2% to about 18% (w/w); from about 10% to about 20% (w/w); or from about 8% to about 14% (w/w).

In some embodiments, the gummy product comprises a first sugar alcohol, a second sugar alcohol, and optionally a third sugar alcohol. In an embodiment, the first sugar alcohol comprises erythritol or sorbitol and the second sugar alcohol comprises glycerin. In another embodiment, the first sugar alcohol comprises erythritol, the second sugar alcohol comprises glycerin, and the third sugar alcohol comprises sorbitol. In an embodiment, the gummy product comprises erythritol from about 0% to about 20% (w/w); from about 5% to about 15% (w/w); from about 9% to about 12% (w/w); from about 2% to about 18% (w/w); from about 10% to about 20% (w/w); or from about 8% to about 14% (w/w). In an embodiment, the gummy product comprises sorbitol from 0% to about 10% (w/w); from about 2.5% to about 7.5% (w/w); from about 4% to about 6% (w/w); from about 2.5% to about 10% (w/w); from about 0% to about 5% (w/w); or from about 3% to about 5% (w/w). In an embodiment, the gummy product comprises glycerin from about 2.5% to about 7.5% (w/w); from about 4% to about 6% (w/w); from about 2.5% to about 10% (w/w); from about 0% to about 5% (w/w); or from about 3% to about 5% (w/w). Examples of glycerin include but are not limited to glycerol (E422) and glycerol monostearate (E471).

Examples of gelatins include but are not limited to 120 Bloom gelatin, 125 Bloom gelatin, 160 Bloom gelatin, 190 Bloom gelatin, 200 Bloom gelatin, 220 Bloom gelatin, 250 Bloom gelatin, and the like. The gelatin can be acid treated. In an embodiment, the gelatin has a bloom strength from about 80 to about 250 Bloom. In another embodiment, the gelatin has a bloom strength from about 125 to about 250 Bloom. In yet another embodiment, the gelatin has a bloom strength of about 160 to about 250 Bloom. In yet another embodiment, the gelatin has a bloom strength of about 190 to about 250 Bloom.

In embodiments, the gummy product comprises gelatin from about 0.5% to about 8% (w/w); from about 0.5% to about 5% (w/w); from about 0.5% to about 3% (w/w); from about 1% to about 11% (w/w); from about 2% to about 11% (w/w); from about 3% to about 11% (w/w); from about 4% to about 11% (w/w); from about 5% to about 11% (w/w); from about 6% to about 11% (w/w); from about 7% to about 11% (w/w); or from about 8% to about 11% (w/w).

The acid can be any acid suitable for use in a snack food product. Examples of suitable acids include but are not limited to malic acid, fumaric acid, lactic acid, tartaric acid, glucono-delta lactone, salts of gluconic acid, phosphoric acid, succinic acid, adipic acid, ascorbic acid, acetic acid, citric acid, and the like. The acid can include a mixture of two or more acids. In an embodiment, the gummy product comprises acid from about 1% to about 4% (w/w); from about 0.5% to about 3% (w/w); or from about 2% to about 4% (w/w). In an embodiment, the gummy product comprises malic acid from about 0% to about 5% (w/w); from about 1% to about 4% (w/w); from about 0.5% to about 3% (w/w); or from about 2% to about 4% (w/w). In an embodiment, the gummy product comprises ascorbic acid from about 0% to about 0.15%; from about 0.08% to about 0.12% (w/w); from about 0.05% to about 0.10% (w/w); from about 0% to about 4% (w/w); from about 1% to about 4% (w/w); from about 0.5% to about 3% (w/w); or from about 2% to about 4% (w/w). In an embodiment, the gummy product comprises ascorbic acid and one or more of malic acid, fumaric acid, lactic acid, tartaric acid, glucono-delta lactone, salts of gluconic acid, phosphoric acid, succinic acid, adipic acid, acetic acid, and citric acid. In an embodiment, the gummy product comprises malic acid and ascorbic acid.

In some embodiments, the gummy product comprises water (moisture content) from about 10% to about 30% (w/w); from about 15% to about 25% (w/w); from about 18% to about 28% (w/w); from about 12% to about 20% (w/w); from about 14% to about 23% (w/w); or from about 20% to about 30% (w/w).

The gummy product of the disclosure generally comprises one or more flavorants and/or colorants. In some embodiments, the gummy product comprises flavorants from 0% to about 0.6% (w/w); from about 0.1% to about 0.5% (w/w); from about 0.2% to about 0.4% (w/w); or from about 0.15% to about 0.35% (w/w). Examples of flavorants include oils including but not limited to spearmint oil, peppermint oil, cinnamon oil, oil of wintergreen (methylsalicylate), clove oil, bay oil, anise oil, eucalyptus oil, thyme oil, cedar leaf oil, oil of nutmeg, oil of sage, oil of bitter almonds, cassia oil, and combinations thereof. The flavorants include artificial, natural or synthetic fruit flavors such as citrus or fruit oils and/or essences including apple, apricot, banana, blueberry, cherry, grape, grapefruit, kiwi, lemon, lime, orange, pear, peach, pineapple, plum, raspberry, strawberry, tangerine and watermelon. Mixtures of the aforementioned flavors are possible.

Additional flavorants include but are not limited to menthol, artificial vanilla, cinnamon derivatives, and various fruit flavors, whether employed individually or in admixture. Flavorings also include, for example, aldehydes and esters including cinnamyl acetate, cinnamaldehyde, citral diethylacetal, dihydrocarvyl acetate, eugenyl formate, p-methylamisol, acetaldehyde (apple); benzaldehyde (cherry, almond), anisic aldehyde (licorice, anise); cinnamic aldehyde (cinnamon); citral, i.e., alpha citral (lemon, lime); ethyl vanillin (vanilla, cream); hellotropine, i.e., piperonal (vanilla, cream); vanillin (vanilla, cream); alpha-amyl cinnamaldehyde (spicy fruity flavors); butyraldehyde (butter, cheese); valcraldehyde (butter, cheese); citronellal; decannal (citrus fruits); aldehyde C-8 (citrus fruits); aldehyde C-9 (citrus fruits); aldehyde C-12 (citrus fruits); 2-ethylbutyraldehyde (berry fruits); tolyl aldehyde (cherry, almond); veratraldehyde (vanilla); 2,6-dimethyl-5-heptenal, i.e., melonal (melon); 2,6-dimethyloctanal (green fruit); and 2-dodecenal (citrus, mandarin), mixtures thereof and the like. Additional flavor compounds include ethylacetate, thiophene, ethylpropionate, ethyl butyrate, 2-hexanoate, 2-methylpyazine, heptaldehyde, 2-octanone, limonene, and eugenol.

In some embodiments, the gummy product comprises colorants from 0% to about 0.6% (w/w); from about 0.1% to about 0.5% (w/w); from about 0.2% to about 0.4% (w/w); or from about 0.15% to about 0.35% (w/w). Colorants include natural or uncertified colors from natural sources or certified colors for the effect of color. In one embodiment, the colorant includes dyes, certified aluminum lakes or colors derived from a natural source. The colorant may be water-based, oil-based or dry. The colorants can be primary colors, blends of colors or discrete mixtures of colors, such as confetti.

The gummy product can optionally be supplemented with one or more vitamins, minerals, and/or amino acids. Examples of vitamins include but are not limited to vitamin E, vitamin C, vitamin B12, vitamin B3, and vitamin B6, and the like. In an embodiment, the gummy product comprises vitamin E from about 0% to about 0.10% (w/w); from about 0.01% to about 0.05% (w/w); from about 0.03% to about 0.05% (w/w); or from about 0.04% to about 0.09% (w/w).

Examples of minerals include but are not limited to magnesium, potassium, iron, calcium, zinc, calcium carbonate, calcium phosphate, calcium citrate, potassium carbonate, potassium phosphate, potassium citrate, and the like. In an embodiment, the gummy product comprises magnesium from about 0% to about 0.12% (w/w); from about 0.03% to about 0.11% (w/w); from about 0.05% to about 0.10%; or from about 0.01% to about 0.07% (w/w). In an embodiment, the gummy product comprises potassium from about 0% to about 0.5% (w/w); from about 0.1% to about 0.4% (w/w); from about 0.2% to about 0.3% (w/w); or from about 0.2% to about 4.2% (w/w).

Examples of supplemental amino acids include but are not limited to histidine, isoleucine, leucine, lysine, methionine, phenylalamine, threonine, tryptophan, valine, alanine, arginine, asparagine, aspartic acid, cysteine, glutamic acid, glutamine, glycine, ornithine, proline, selenocysteine, serine, tyrosine, and combinations thereof. In an embodiment, the gummy product comprises from about 0.05% to about 10% supplemental amino acids. In an embodiment, the supplemental amino acids comprise branch chain amino acids (BCAA). Examples of BCAA include leucine, isoleucine, and valine. Preferably the supplemental amino acids comprise the L isomer (e.g., L-amino acids). In an embodiment, the gummy product comprises BCAA from about 0% to about 5% (w/w); from about 1% to about 4% (w/w); from about 2% to about 3% (w/w); or from about 2% to about 5% (w/w). In an embodiment, the gummy product comprises glutamine from about 0% to about 6%; from about 1% to about 5% (w/w); from about 2% to about 4% (w/w); from about 3% to about 6% (w/w); or from about 0.1% to about 3% (w/w).

The gummy product can optionally include an emulsifier. Examples of emulsifiers include but are not limited to sucrose esters, soy lecithin, sunflower lecithin, egg lecithin, lecithins and combinations thereof. In an embodiment, the gummy product comprises an emulsifier from about 0% to about 1% (w/w); from about 0.2% to about 0.8% (w/w); from about 0% to about 0.5% (w/w); from about 0.5% to about 1% (w/w); from about 0.3% to about 0.6% (w/w); or from about 0.1% to about 0.5% (w/w). In another embodiment, the gummy product comprises sucrose esters from about 0% to about 1% (w/w); from about 0.2% to about 0.8% (w/w); from about 0% to about 0.5% (w/w); from about 0.5% to about 1% (w/w); from about 0.3% to about 0.6% (w/w); or from about 0.1% to about 0.5% (w/w).

The gummy product of the disclosure can optionally be coated with a wax and/or oil. Examples of suitable wax include but are not limited to carnauba wax, bees wax, and the like. Examples of suitable oils include but are not limited to mineral oil, coconut oil, vegetable oil, and the like. The gummy product of the disclosure can further be coated with a flavorant, such as sugar granules or flavor particles.

The gummy product of the disclosure comprises a unique gel structure unlike that of existing gummy products that use gelatin, starch, pectin, or agar. The gel structure is partially aerated and comprises a gelatin matrix in which protein interrupts the gelatin matrix. Without wishing to be bound to a particular theory, it is believed that the high quality protein, such as whey protein isolate, aggregates slightly in the gummy product which interrupts the gelatin matrix. As a result, the gel structure of the gummy product of the disclosure is more porous than a pure gelatin gummy and maintains resilience (e.g., spring back) while having less cohesion (e.g., faster breakdown) while chewing. In contrast, starch gels such as in fruit snacks have a long texture with very little resilience and agar gels are porous but brittle having less cohesion and less resilience than the gummy product of the disclosure.

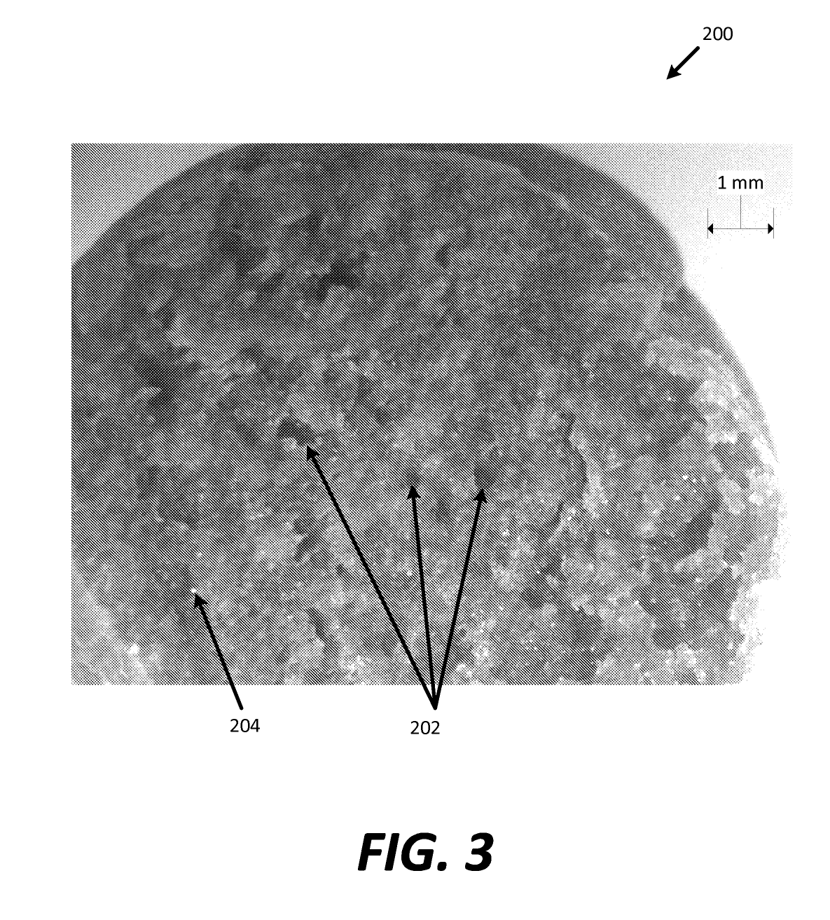

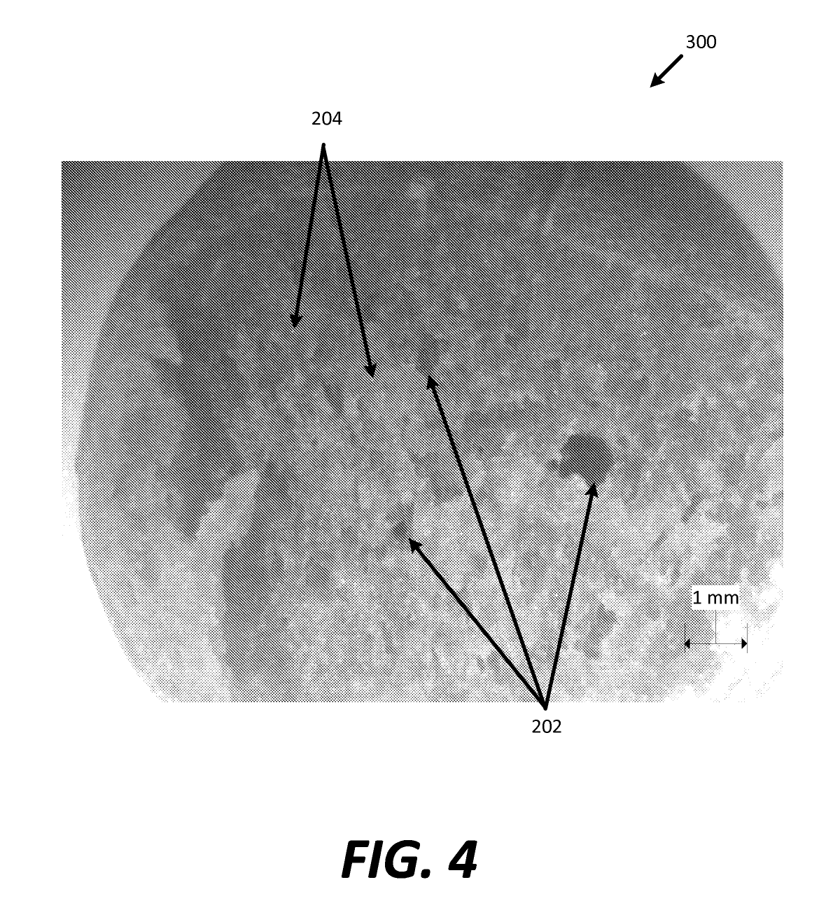

FIGS. 3 and 4 show photomicrographs of a cross section of example gummy products 200 and 300. Air pockets or air cells 202 are randomly dispersed throughout the gel structure of gummy products 200 and 300. In embodiments, the air cells have an average diameter of about 50 microns to about 500 microns, from about 50 microns to about 400 microns, from about 50 microns to about 300 microns, or from about 50 microns to about 200 microns. In embodiments, the gummy product of the disclosure comprises from about 5 to about 50 air cells per mm², from about 5 to about 40 air cells per mm², from about 5 to about 30 air cells per mm², from about 5 to about 20 air cells per mm², or from about 5 to about 10 air cells per mm² of cross-sectional area. In embodiments, the gummy products can contain crystals formed from the sugar alcohol dispersed within the gelatin matrix. FIGS. 3 and 4 show crystals 204 of erythritol dispersed within the gelatin matrix.

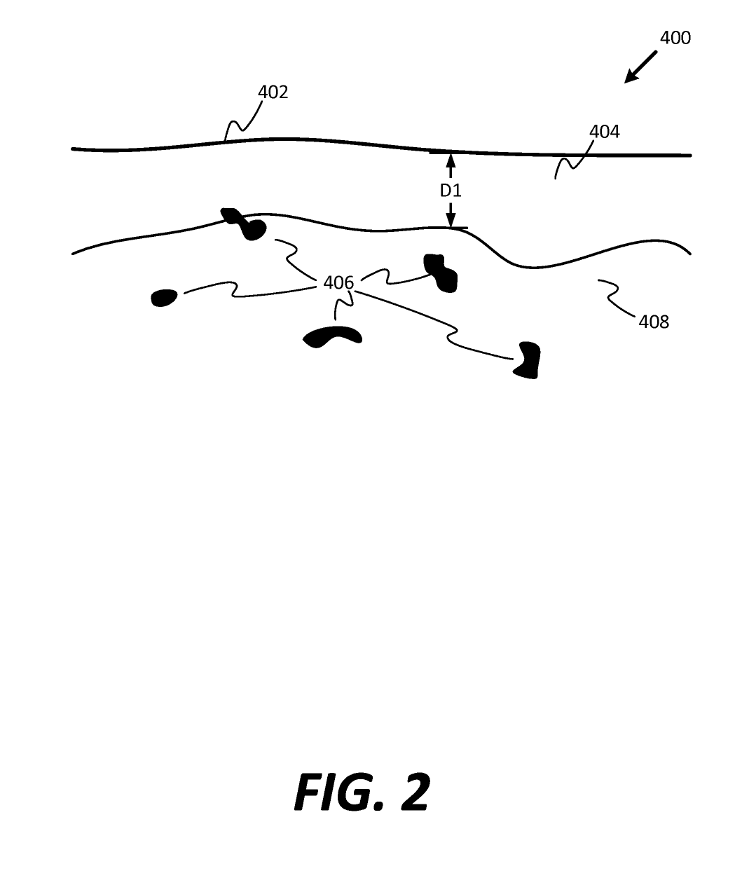

The gel structure of the gummy product of the disclosure can also be semi-crystalline with a substantial amount of the crystallization forming at an outer surface of the gummy product. FIG. 2 is an illustration of a magnified view of a cross-section of an example high protein gummy 400. The exterior surface of the gummy 402 can have a starch layer 404 of varying thickness D1. The starch layer 404 can be attributed to the starch molds used to form the gummy product as described herein. The starch layer 404 can have a thickness D1 of from about 0.01 mm to about 2 mm; of from about 0.2 mm to about 1.5 mm; of from about 0.8 mm to about 1.2 mm; of from about 0.3 mm to about 1 mm; of from about 0.1 mm to about 0.9 mm; or of from about 0.5 mm to about 1.1 mm. In embodiments, crystals 406 formed by the sugar alcohol, such as erythritol, can be present in or near the interface of the starch layer 404 with the gelatin matrix 408. The crystals 406 can be further dispersed within the gel structure. In embodiments, the crystals 406 are dendritic crystals. In embodiments, the crystals 406 are present in the highest concentration at or near the interface of the starch layer 404 with the gelatin matrix 408.

In embodiments, the gummy product has a density of from about 0.6 g/cm³ to about 1.4 g/cm³; of from about 0.7 g/cm³ to about 1.3 g/cm³; of from about 0.8 g/cm³ to about 1.2 g/cm³; of from about 0.9 g/cm³ to about 1.1 g/cm³; of from about 0.8 g/cm³ to about 1.0 g/cm³; of from about 1.0 g/cm³ to about 1.2 g/cm³; from about 0.9 g/cm³ to about 1.2 g/cm³; of from about 0.7 g/cm³ to about 1.1 g/cm³; of from about 0.85 g/cm³ to about 1.15 g/cm³; of from about 0.95 g/cm³ to about 1.05 g/cm³; or of from about 1.05 g/cm³ to about 1.25 g/cm³.

The gel structure of the gummy product of the disclosure can be further characterized by textural analysis, such as firmness and resilience (also known as spring back). Firmness and resilience can be measured using a TA.TX texture analyzer (Texture Technologies; Hamilton, Mass.) using conventional methods. Firmness and resilience of the gel structure can be measured in grams force using a TA.TX texture analyzer in compression mode. In embodiments, the gummy product comprises a gel structure having a firmness measured in grams force of from about 450 g to about 1550 g; of from about 500 g to about 1400 g; of from about 700 g to about 1300 g; of from about 800 g to about 1200 g; of from about 900 g to about 1100 g; of from about 700 g to about 1000 g; of from about 850 g to about 1350 g; of about 600 g to about 900 g; of from about 550 g to about 750 g; or of from about 925 g to about 1275 g.

In embodiments, the gummy product comprises a gel structure having a resilience of from about 20% to about 60% spring back after being held under about 20% compression strain for about one minute. In further embodiment, the gummy product comprises a gel structure having a resilience of from about 25% to about 55% spring back; of from about 35% to about 45% spring back; of from about 30% to about 50% spring back; of from about 20% to about 40% spring back; of from about 40% to about 60% spring back; of from about 30% to about 60% spring back; or of from about 25% to about 45% spring back after being held under about 20% compression strain for about one minute. Over the shelf life of the gummy product, the spring back may be reduced by about 10% to about 80%; by about 20% to about 70%; by about 30% to about 60%; or by about 40% to about 50%.

In embodiments, firmness and/or resilience is measured at one or more time points during the shelf-life of the gummy product. In embodiments, the firmness and/or resilience is measured at about 0 days to about 90 days after production of the gummy product; at about 1 day to about 100 days after production of the gummy product; or at about 7 days to about 80 days after production.

The gummy product of the disclosure can be provided in multiple sizes and shapes as desired, including but not limited to, geometric shapes such as a cylinder, sphere, cube, pyramid, and the like; and novelty shapes such as novelty characters, bears, stars, worms, rings fruit, and the like. In one embodiment, the high protein gummy product is in the shape of a substantially rounded cylinder, such as a dot form or rounded, truncated cone, or cylinder form. The individual pieces in that embodiment have a diameter of from about 14 mm to about 18 mm; from about 12 mm to about 20 mm; from about 13 mm to about 15 mm; or from about 15 mm to about 18 mm. The individual pieces in that embodiment have a height of from about 14 mm to about 22 mm; from about 15 mm to about 20 mm; from about 16 mm to about 18 mm; or from about 17 mm to about 22 mm. In an embodiment, the weight of an individual piece can be from about 1 gram to about 10 grams; from about 1 gram to about 8 grams; from about 1 gram to about 6 grams; from about 1 gram to about 4 grams; from about 2 grams to about 4 grams; from about 2.2 grams to about 2.8 grams; from about 2.5 grams to about 3.5 grams; or from about 3 grams to about 4 grams.

In an embodiment, a suggested serving size is about 85 grams of individual pieces, which includes about 20 grams of protein. In an embodiment, each individual piece has from about 0.25 to about 0.8 gram of protein; from about 0.5 to about 0.8 gram of protein, or from about 0.5 to about 1 gram of protein; from about 0.8 to about 1.6 grams of protein; or from about 1.4 grams to about 1.8 grams of protein.

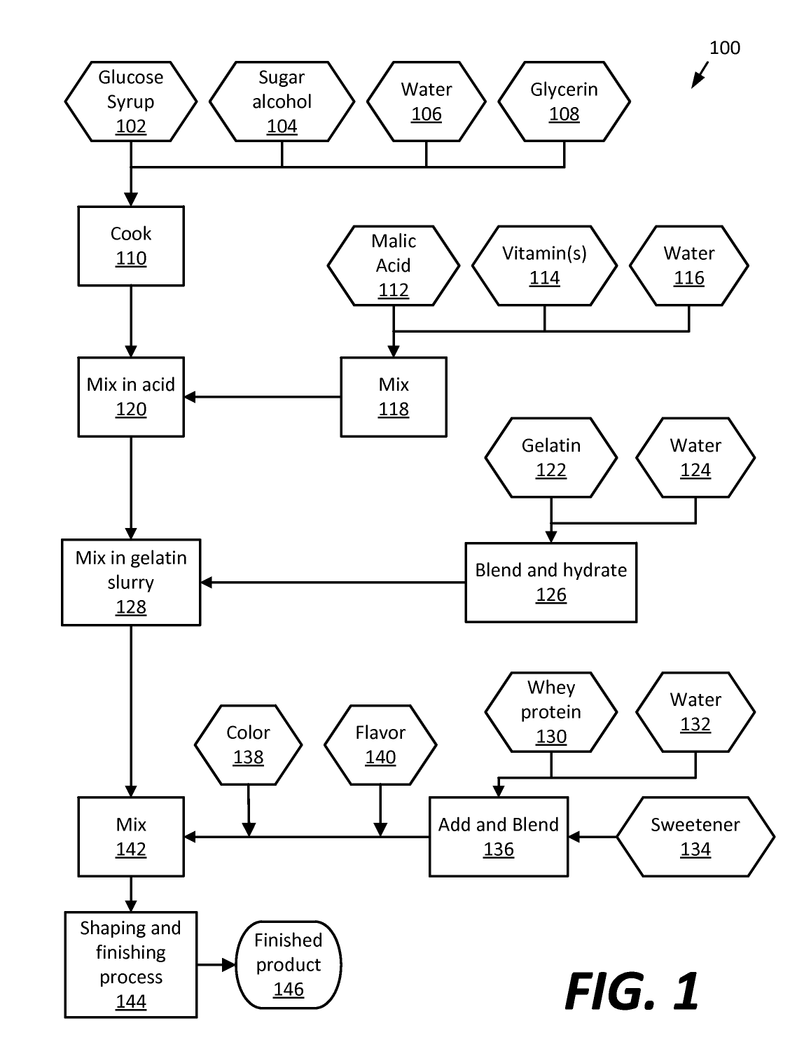

FIG. 1 illustrates an exemplary method 100 of producing a high protein gummy product of the disclosure. The method 100 can include glucose syrup 102, sugar alcohol 104, water 106, glycerin 108, cooking step 110, malic acid 112, vitamin(s) 114, water 116, mixing step 118, mix in acid step 120, gelatin acid 122, water 124, blend and hydrate step 126, mix in gelatin slurry step 128, whey protein 130, water 132, sweetener 134, add and blend step 136, color 138, flavor 140, mix step 142, to shaping and finishing process step 144, and resulting in finished product 146. Other embodiments may have more or fewer steps and ingredients. The method 100, or parts of the method 100, may be performed in either a batch or a continuous operating mode.

In some embodiments, the exemplary method 100 begins by cooking 110 a mixture of glucose syrup 102, sugar alcohol 104, water 106 and glycerin 108. The glucose syrup 102 can be corn syrup, tapioca syrup, agave syrup, brown rice syrup, glucose syrup, high maltose syrup, invert sugar, or mixtures thereof as described herein. The glucose syrup 102 can be from about 15% to about 100% (w/w); from about 20% to about 80%; from about 30% to about 40%; from about 15% to about 40%; from about 15% to about 60%; or from about 40% to about 100% (w/w) of the ingredients added to cooking step 110.

The sugar alcohol 104 optionally added to cooking step 110 is, in example process 100, erythritol. However, the process sugar alcohol 104 can be any of the sugar alcohols as described herein, and may comprise more than one sugar alcohol. The sugar alcohol 104 can be from about 0% to about 20% (w/w); from about 5% to about 15% (w/w); from about 8% to about 12% (w/w); from about 5% to about 20% (w/w); from about 0% to about 10% (w/w); or from about 5% to about 10% (w/w) of the ingredients added to cooking step 110.

The water 106 added to cooking step 110 is tap water. In some embodiments, the water 106 is de-ionized and/or distilled. The temperature of the water can be from about 70° F. to about 180° F.; from about 80° F. to about 160° F.; from about 75° F. to about 150° F.; or from about 100° F. to about 170° F. The water 106 generally comprises the balance of the (w/w) of the ingredients added to cooking step 110.

Glycerin 108 can be optionally added to cooking step 110. The glycerin typically is a food-safe glycerol. In some embodiments, glycerin 108 comprises, for example, glycerol (E422) or glycerol monostearate (E471). Glycerin and additional sugar alcohols that can be added in addition to, or in place of, glycerin, are described herein. The glycerin 108 comprises from about 0% to about 10% (w/w); from about 2.5% to about 7.5% (w/w); from about 4% to about 6% (w/w); from about 2.5% to about 10% (w/w); from about 0% to about 5% (w/w); or from about 3% to about 5% (w/w) of the ingredients added to cooking step 110.

Cooking step 110 includes mixing the glucose syrup 102, optionally sugar alcohol 104, water 106, and optionally glycerin 108 and raising the temperature of the mixture for a period of time. In an embodiment operating in a continuous system, cooking step 110 can also include gelatin 122. In some embodiments, the mixture fed to cooking step 110 is simply glucose syrup or a mixture of glucose syrup and water. In batch cooking system embodiments, the cooking apparatus can be, for example, an open kettle system. In continuous cooking system embodiments, the cooking apparatus can be, for example, a coil cooker or a jet cooker that can be followed by a vacuum chamber to remove water.

In some embodiments, the mixture's temperature is raised in cooking step 110 to from about 230° F. to about 285° F.; from about 260° F. to about 280° F.; from about 240° F. to about 265° F.; or from about 275° F. to about 285° F. The cooking time of the mixture is generally from about 10 to about 30 minutes; from about 20 to about 30 minutes; from about 10 to about 60 minutes; from about 30 to about 60 minutes; from about 35 to about 55 minutes; or from about 25 to about 30 minutes.

At the end of cooking step 110, the mixture is cooled to ambient temperature, from about 60° F. to about 85° F.; from about 65° F. to about 75° F.; from about 75° F. to about 80° F.; or from about 70° F. to about 78° F. After cooling, the solids content is from about 60% to about 95% by mass; from about 75% to about 95%; from about 80% to about 90%; or from about 82% to about 86% by mass.

Malic acid 112, vitamin(s) 114 and water 116 are mixed in step 118. In some embodiments, the malic acid 112 is alternatively one or a mixture of more than one of the acids described herein. Adding the malic acid 112, in some embodiments, has the effect of lowering the pH of the mixture exiting step 118.

One or more vitamins 114 are also optionally mixed in step 118. In some embodiments, the vitamins 114 are alternatively vitamin A, vitamin B5, vitamin B6, vitamin B12, biotin, folate, niacin, riboflavin, thiamine, and tocopherols. In some embodiments, minerals and supplemental amino acids, as described above, can also be added. In some embodiments, vitamins, minerals, and/or supplemental amino acids can be added with the whey protein 130.

Water 116 can be preheated before mixing in step 118. In some embodiments, water 116 is tap water. In some embodiments, water 116 is de-ionized and/or distilled. In some embodiments, the water 116 temperature is from about 140° F. to about 160° F.; from about 150° F. to about 170° F.; or from about 155° F. to about 165° F.

Mixing step 118 mixes the malic acid 112, vitamin(s) 114, and water 116 until the acids are fully dissolved. In some embodiments, mixing step 118 only mixes malic acid and water. The pH of the mixture exiting step 118 is from about 2 to about 4; from about 2.5 to about 3.5; or from about 2 to about 2.5. A mixing apparatus such as one previously described can be used for mixing 118.

The outputs of mixing step 118 and cooking step 110 are mixed in step 120. A mixing apparatus such as one previously described can be used for mixing 120. The pH of the mixture exiting step 120 is from about 2 to about 3; from about 2 to about 2.5; or from about 1.8 to about 2.2.

Gelatin 122 and water 124 are mixed in the blend and hydrate step 126. In some embodiments, the gelatin 122 is acid processed, also known as acid treated. The gelatin can be any of the gelatins described in more detail above.

Water 124 can be preheated before mixing in step 126. In some embodiments, water 124 is tap water. In some embodiments, water 124 is de-ionized and/or distilled. In some embodiments, the water 124 temperature is from about 140° F. to about 160° F.; from about 150° F. to about 170° F.; or from about 155° F. to about 165° F.

During step 126, the water 124 is used to hydrate the gelatin 122. Step 126 blends the water 124 and gelatin 122 for from about 20 minutes to about 30 minutes; from about 20 minutes to 40 minutes; from about 20 minutes to about 25 minutes; or from about 15 minutes to about 25 minutes. The output of step 126 can have a temperature of from about 75° F. to about 150° F.; from about 80° F. to about 140° F.; from about 75° F. to about 100° F.; or from about 100° F. to about 130° F.

In some embodiments, the gelatin slurry can be from about 35% to about 65% (w/w) gelatin; from about 40% to about 60% (w/w) gelatin; from about 45% to about 55% (w/w) gelatin; or from about 35% to about 60% (w/w) gelatin.

The outputs of steps 120 and 126, the sugar-acid mixture the gelatin slurry, respectively, are mixed in step 128. The two outputs are mixed for from about 4 to about 10 minutes; from about 5 to about 8 minutes; or from about 5 to about 12 minutes. The temperature of the mixture exiting mixing step 128 is from about 160° F. to about 270° F.; from about 180° F. to about 260° F.; or from about 200° F. to about 265° F. In some embodiments, the gelatin slurry can be from about 5% to about 25% (w/w) of the sugar-acid mixture; from about 10% to about 20% (w/w) of the sugar-acid mixture; from about 15% to about 20% (w/w) of the sugar-acid mixture; or from about 5% to about 20% (w/w) of the sugar-acid mixture.

Whey protein 130 and water 132 are blended in step 136. Sweetener 134 is optionally also added to blending step 136. In some embodiments, the sweetener 134 is added when the mixture of whey protein 130 and water 132 is smooth. In some embodiments, supplemental amino acids as described herein can be added to blending step 136.

In some embodiments, the whey protein 130 comprises one or more suitable commercially available, high quality whey protein products described above. In some embodiments, the whey protein 130 is a whey protein concentrate, a whey protein hydrolysate, a whey protein isolate, or a mixture thereof.

Water 132 is generally provided at ambient temperature when used in blending step 136. In some embodiments, water 132 is tap water. In some embodiments, water 132 is de-ionized and/or distilled. In some embodiments, the water 132 temperature is from about 60° F. to about 85° F.; from about 65° F. to about 75° F.; from about 75° F. to about 80° F.; or from about 70° F. to about 78° F. In some embodiments, the water and protein are mixed in a ratio of about 2 parts water to about 1 part protein; about 1 part water to about 2 parts protein; about 1 part water to about 1 part protein; about 3 parts water to 2 about parts protein; about 2 parts water to about 3 parts protein; about 1 part water to about 3 parts protein; or about 3 parts water to about 1 part protein.

Mixing step 136 includes adding the whey protein 130 to the water 132, or adding water 132 to the whey protein 130. In some embodiments, a double action mixer, or a paddle mixer, such as a Hobart mixer or a Kitchen Aid stand mixer can be used in step 136. In some embodiments, the mixing is performed without aerating. In some embodiments, the mixing is performed gently, that is, at low speed and low flow rate of whey protein 130 so as to not aerate and/or create foam in the mixture.

In some embodiments, the output from step 136, the protein mixture, can be from about 25% to about 65% (w/w) protein; from about 35% to about 55% (w/w) protein; from about 30% to about 60% (w/w) protein; or from about 40% to about 65% (w/w) protein.

Sweetener 134 is optionally added to the mixing step 136. Sweeteners that can be used include, for example, natural sweeteners such as stevia, or artificial sweeteners such as sucralose, dextrose, aspartame, Sweet-N-Low, Equal, or Splenda.

Flavorants 140 are optionally added to the output of add and blend step 136. Examples of flavorants 140 are described herein.

Colorants 138 are optionally added to the mixture exiting blending step 136. Examples of colorants 138 are described herein.

Mixing step 142 combines the sugar and gelatin mixture, the output from mixing 128, with the protein mixture, the output from blending step 128, with the optional flavorant 140 and colorant 138 additives. The combined mixture is mixed until smooth. In some embodiments, the combined mixture is mixed for from about 8 to about 12 minutes; from about 10 to about 14 minutes; from about 5 to about 20 minutes; or from about 9 to about 11 minutes. In some embodiments, the protein mixture can be mixed with the sugar and gelatin mixture at from about 30% to about 80% (w/w) of the sugar and gelatin mixture weight; from about 40% to about 70% (w/w) of the sugar and gelatin mixture weight; from about 50% to about 65% (w/w) of the sugar and gelatin mixture weight; or from about 35% to about 75% (w/w) of the sugar and gelatin mixture weight.

In some embodiments, the mixing step 142 is accomplished using a double-action mixer. In some embodiments, there is substantially no aeration during mixing.

The mixing step 142 optionally includes a holding period after the mixture becomes smooth. In some embodiments, the mixture is held for from about 8 to about 12 minutes; from about 10 to about 14 minutes; from about 5 to about 20 minutes; or from about 9 to about 11 minutes. As used herein, a holding period is a period when the agitating apparatus in the vessel are turned off and/or the vessel itself is not rotating or otherwise moving.

The optional holding period during mixing step 142 optionally includes maintaining the temperature of the mixture. In some embodiments, the temperature of the mixture is maintained during holding from about 140° F. to about 175° F.; from 140° F. to about 160° F.; from about 150° F. to about 170° F.; or from about 155° F. to about 165° F.

The output from mixing step 142, a “gummy slurry,” has a pH of from about 2.0 to about 5.0; from about 3.0 to about 4.6; from about 3.4 to about 3.6; from about 3.1 to about 4.0; from about 2.3 to about 3.5 or from about 3.5 to about 4.7.

The output from mixing step 142 has a density of from about 1.0 to about 1.4 grams/cm³; from about 1.05 to about 1.3 grams/cm³; from about 1.1 to about 1.25 grams/cm³; from about 1.15 to about 1.2 grams/cm³; from about 1.0 to about 1.2 grams/cm³; or from about 1.15 to about 1.35 grams/cm³.

The output from mixing step 142, the gummy slurry, is sent to one or more shaping and finishing processes 144. For example, the gummy slurry is optionally sent to a mogul hopper, depositor, or extruder. In some embodiments, the shaping process 144 is a gummy-forming process that can use, for example, a starch mogul. The output may be deposited in various molds, such as, for example, bear-shaped molds, worm-shaped molds, dot-shaped (roughly a rounded, truncated cone or rounded cylinder) molds, pill-shaped molds, fish-shaped molds, ring-shaped molds, fruit-shaped molds, and the like. The molds may be a starch mold, for example a corn starch mold.

In some embodiments, the finishing process 144 may include drying or curing the gummy slurry-containing starch mold trays. In some embodiments, the finishing process 144 may include separating the cured gummy products from the starch mold trays and/or separating the gummy products from any residual starch from the starch molds.

In some embodiments, the finishing process 144 may include extruding the gummy slurry and drying or curing the resulting ropes, twists, or vines.

The finished product 146 is ready for assembly in individual or group packaging. The finished product 146 can have one of the aforementioned shapes or be of a rope or a twisted geometry. The finished product 146 can have one of the aforementioned coatings or flavor depositions on its surface.

### EXAMPLE

The following example is illustrative, and other embodiments are within the scope of the present disclosure.

### Example 1

### Structural and Textural Analysis of High Protein Gummy Product

An example embodiment of the high protein gummy product of the disclosure was examined using light microscopy. The gel structure of the high protein gummy product was found to be interrupted by protein and partially aerated with many air cells dispersed throughout the gel matrix (see FIGS. 3 and 4) indicating that the gummy product can be characterized as a foam structure. Additionally, a starch layer of varying degrees of thickness was present at or near the surface of the gummy product and was likely attributable to the starch molds used to form the gummy product. Crystals formed from erythritol were found at or near the surface of the gummy and were generally found in clusters at the interface between the starch layer and gelatin matrix. In some instances, erythritol crystals were also found in the interior of the gummy product dispersed within the gelatin matrix.

Textural analysis of the high protein gummy product was performed using a TA.XT Texture Analyzer from Texture Technologies (Hamilton, Mass.). Firmness and resilience of the gel structure was measured in grams force using the TA.TX texture analyzer in compression mode. The firmness and resilience of the gel structure of the high protein gummy were compared to a gelatin confectionary gel, a pectin confectionary gel, and a starch confectionary gel. The results of this analysis are shown in Table 1.

TABLE 1

| | Firmness, Grams | |
|---|---|---|
| | Force | Spring back, % |
| Example Gummy | 1000 ± 550 | 20-60 |
| Product | | |
| Gelatin | 85.0 ± 50.0 | 30-50 |
| Confectionary | | |
| Pectin | 400.0 ± 50 | 30-50 |
| Confectionary | | |
| Starch | 2200 ± 300 | 0-10 |
| Confectionary | | |

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A gummy snack food product, comprising:
from about 10% to about 40% high quality protein by weight;
from about 15% to about 55% of glucose syrup by weight;
from 0% to about 20% of a first sugar alcohol by weight;
from 0% to about 10% of a second sugar alcohol by weight, the second sugar alcohol comprising glycerin;
from about 0.5% to about 11% gelatin by weight;
from 0% to about 5% acid by weight; and
from about 10% to about 30% water by weight.

2. The product of claim 1, wherein the high quality protein comprises whey protein, milk protein concentrate, milk protein isolate, casein, micellar casein, caseinate protein, casein protein hydrolysate, vegetable protein, vegetable protein isolate, egg protein, egg white protein, beef protein isolate, mycoprotein or mixtures thereof.

3. The product of claim 2, wherein the whey protein comprises at least 80% protein by weight.

4. The product of claim 3, wherein the whey protein comprises whey protein concentrate, whey protein isolate, whey protein hydrolysate, or a combination thereof.

5. The product of claim 4, wherein the high quality protein comprises whey protein isolate.

6. The product of claim 5, wherein the whey protein isolate is partially hydrolyzed.

7. The product of claim 6, wherein the whey protein isolate comprises an isoelectric point of about 4 to about 5.5.

8. The product of claim 5, wherein the gummy snack food product comprises from about 10% to about 30% whey protein isolate by weight.

9. The product of claim 2, wherein the vegetable protein comprises pea protein, brown rice protein, sprouted brown rice protein, hemp protein, soy protein, soy protein isolate, or mixtures thereof.

10. The product of claim 1, wherein the glucose syrup comprises corn syrup, tapioca syrup, agave syrup, brown rice syrup, high maltose syrup, invert sugar, or a mixture thereof.

11. The product of claim 10, wherein the glucose syrup is corn syrup.

12. The product of claim 11, wherein the corn syrup comprises a dextrose equivalent (DE) of about 40 to about 70 DE.

13. The product of claim 11, wherein the gummy snack food product comprises from about 15% to about 25% corn syrup by weight.

14. The product of claim 1, wherein the first sugar alcohol comprises erythritol, sorbitol, or a combination thereof.

15. The product of claim 14, wherein the gummy snack food product comprises from about 2% to about 18% of the first sugar alcohol by weight.

16. The product of claim 1, wherein the acid comprises malic acid, fumaric acid, lactic acid, tartaric acid, glucono-delta lactone, salts of gluconic acid, phosphoric acid, succinic acid, adipic acid, acetic acid, citric acid, or a combination thereof.

17. The product of claim 16, wherein the gummy snack food product further comprises from about 0% to about 0.4% ascorbic acid by weight.

18. The product of claim 1, wherein the gelatin comprises a bloom strength of about 125 to about 250 Bloom.

19. The product of claim 1, further comprising one or more flavorants, one or more colorants, one or more vitamins, or one or more minerals.

20. The product of claim 19, wherein the gummy snack food product comprises from about 0% to about 0.10% vitamin E by weight, from about 0% to about 0.12% magnesium by weight, and from about 0% to about 0.5% potassium by weight.

21. The product of claim 1, further comprising from about 0% to about 10% on ore more supplemental amino acids by weight.

22. The product of claim 1, wherein the gummy snack food product comprises a gelatin matrix, the gelatin matrix interrupted by aggregates of the high quality protein and/or air cells dispersed throughout the gelatin matrix.

23. The product of claim 1, wherein the gummy snack food product comprises a piece size of about 1 to about 10 grams.

24. The product of claim 1, wherein the gummy snack food product comprises a firmness of from about 500 g to about 1500 g.

25. The product of claim 1, wherein the gummy snack food product comprises a resilience of from about 20% to about 60%.

26. The product of claim 1, wherein the gummy snack food product comprises a density of from about 0.8 g/cm³ to about 1.2 g/cm³.

27. A method for producing a gummy snack food product, comprising:
forming a mixture comprising from about 15% to about 55% (w/w) corn syrup, from 0% to about 20% (w/w) of a first sugar alcohol, from 0 to about 10% (w/w) of second sugar alcohol, and from about 10% to about 30% (w/w) water;
cooking the mixture to form a sugar mixture;
cooling the sugar mixture and mixing the cooled sugar mixture with an acid solution to form a sugar-acid mixture having a pH of about 2 to about 4;
mixing the sugar-acid mixture with a gelatin slurry to form a sugar-gelatin mixture, the gelatin slurry comprising from about 35% to about 60% (w/w) hydrated gelatin;
mixing the sugar-gelatin mixture with a protein mixture to form a gel mixture, the protein mixture comprising from about 25% to about 65% (w/w) high quality protein; and
depositing the gel mixture into a starch mold.

28. A gel slurry for use in a molding or extruding process, comprising:
from about 10% to about 40% high quality protein by weight;
from about 15% to about 40% of glucose syrup by weight;
from 0% to about 20% of a first sugar alcohol by weight;
from 0% to about 10% of a second sugar alcohol by weight, the second sugar alcohol comprising glycerin;
from about 0.5% to about 11% gelatin by weight;
from 0% to about 5% acid by weight; and
from about 10% to about 30% water by weight;
wherein the gel slurry has a density of about 1.0 to about 1.4 grams/centimeters³ and a pH of about 2.3 to about 4.6.
